(19) United States
(12) Patent Application Publication
(10) Pub. No.: US 2013/0304282 A1
(43) Pub. Date: Nov. 14, 2013

(54) APPARATUS FOR UNMANNED VEHICLE

(71) Applicants: Kevin William Beggs, Preston (GB); Richard Descond Joseph Axford, Shrivenham (GB)

(72) Inventors: Kevin William Beggs, Preston (GB); Richard Descond Joseph Axford, Shrivenham (GB)

(73) Assignee: BAE SYSTEMS PLC, LONDON (GB)

(21) Appl. No.: 13/996,812

(22) PCT Filed: Dec. 14, 2011
(86) PCT No.: PCT/EP11/72723

§ 371 Date: Jun. 21, 2013

(30) Foreign Application Priority Data
Dec. 23, 2010 (EP) 10252210.9
Dec. 23, 2010 (GB) 1021960.8

(51) Int. Cl. B64D 45/00

(52) U.S. Cl. CPC B64D 45/00
USPC 701/3

(57) ABSTRACT

An apparatus and a method are disclosed, such as an apparatus wholly or partially mounted on an unmanned vehicle and arranged to act upon a payload, the payload being mounted on the unmanned vehicle and, under an action of the apparatus, being changeable from being in a first state to being in a second state. The method can include: receiving an instruction that the unmanned vehicle, with the payload mounted thereon, is to travel to a location; determining that the payload is in the first state; and responsive to determining that the payload is in the first state: opposing the payload being changed to being in the second state; and providing, for an entity remote from the unmanned vehicle, an indication that the payload is in the first state.

### FIELD OF THE INVENTION

The present invention relates to apparatus for use on unmanned vehicles.

### BACKGROUND

Unmanned air vehicles (UAVs) are used to deliver payloads (e.g. lethal effectors such as explosives, or non-lethal effectors such as communications jamming devices) to targets.

Typically, such payloads containing energetic material are activated or armed prior to being delivered. This activation or arming may be performed whilst the payload is onboard the UAV, e.g. whilst airborne.

Conventionally, once a UAV comprising such a payload is launched from a base, the UAV/payload is not permitted to be returned to a friendly location (e.g. the base). This tends to be the case even if the payload on the UAV has not been armed or activated.

Typically, the return of the payload is not permitted because the risk of the payload having a detrimental effect on the location it is returned to is deemed to be too high.

### SUMMARY OF INVENTION

According to a first aspect of the present invention there is provided a method performed by apparatus, the apparatus being wholly or partially mounted on an unmanned vehicle and arranged to act upon a payload, the payload being mounted on the unmanned vehicle and, under an action of the apparatus, able to be changed from being in a first state to being in a second state, the method comprising: receiving an instruction that the unmanned vehicle, with the payload mounted thereon, is to travel to a location; determining that the payload is in the first state; and responsive to the step of determining that the payload is in the first state: opposing the payload being changed to being in the second state; and providing, for an entity remote from the unmanned vehicle, an indication that the payload is in the first state.

Operation of the payload in the first state may be restricted, compared to operation of the payload in the second state.

The step of opposing the payload being changed to being in the second state may comprise disabling a mechanism by which the payload is changed to being in the second state.

The step of opposing the payload being changed to being in the second state may comprise opposing the release of a safety device.

The safety device may comprise an electrical connection and a mechanical connection.

The entity may be at the location.

The payload may be a lethal effector.

The step of providing, for an entity remote from the unmanned vehicle, an indication that the payload is in the first state may be performed at a plurality of time-steps in a time period.

The method may additionally comprise travelling, with the payload mounted on the unmanned vehicle, to the location.

The aforementioned time period may extend at least from a first point in time to a second point in time, the first point in time being a point in time at which the instruction is received, and the second point in time being a point in time at which the unmanned vehicle arrives at the location.

According to a further aspect of the present invention there is provided apparatus, wholly or partially mounted on an unmanned vehicle and arranged to act upon a payload, the payload being mounted on the unmanned vehicle and, under an action of the apparatus, able to be changed from being in a first state to being in a second state, the apparatus being arranged to: receive an instruction that the unmanned vehicle, with the payload mounted thereon, is to travel to a location; determine that the payload is in the first state; and in response to determining that the payload is in the first state, the apparatus being further arranged to: oppose the payload being changed to being in the second state; and provide, for an entity remote from the unmanned vehicle, an indication that the payload is in the first state.

Operation of the payload in the first state may be restricted compared to operation of the payload in the second state.

The opposing step may comprise disabling a mechanism by which the payload is changed to being in the second state.

According to a further aspect of the present invention there is provided a program or plurality of programs arranged such that when executed by a computer system or one or more processors it/they cause the computer system or the one or more processors to operate in accordance with the aforementioned method.

According to a further aspect of the present invention there is provided a machine readable storage medium storing the, or each, aforementioned program.

### BRIEF DESCRIPTION OF THE DRAWINGS

FIG. 1 is a schematic illustration (not to scale) of an example unmanned air vehicle in which an embodiment of a payload arming and delivery process is implemented;

FIG. 2 is a schematic illustration (not to scale) of an example scenario in which the UAV is used to implement the embodiment of the payload arming and delivery process;

FIG. 3 is a process flow-chart showing certain steps of an embodiment of the payload arming and delivery process; and

FIG. 4 is a process flow chart showing certain steps of the UAV return process.

### DETAILED DESCRIPTION

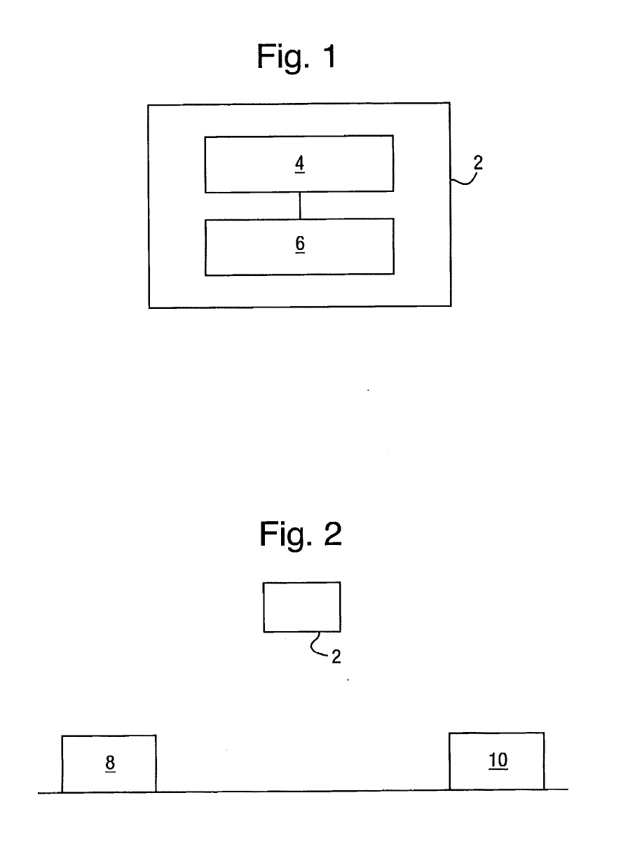

FIG. 1 is a schematic illustration (not to scale) of an example unmanned air vehicle, hereinafter referred to as “the UAV 2” in which an embodiment of a payload arming and delivery process is implemented. For example, the UAV 2 may be a “Coyote” or “Silver Fox” type UAV. The UAV 2 may, for example, weigh up to one tonne. The UAV 2 may, for example, have a wing-span of 2-3 metres.

In this example, the UAV 2 comprises a payload arming system 4, and a payload 6.

In this embodiment, the UAV 2 is an autonomous air vehicle.

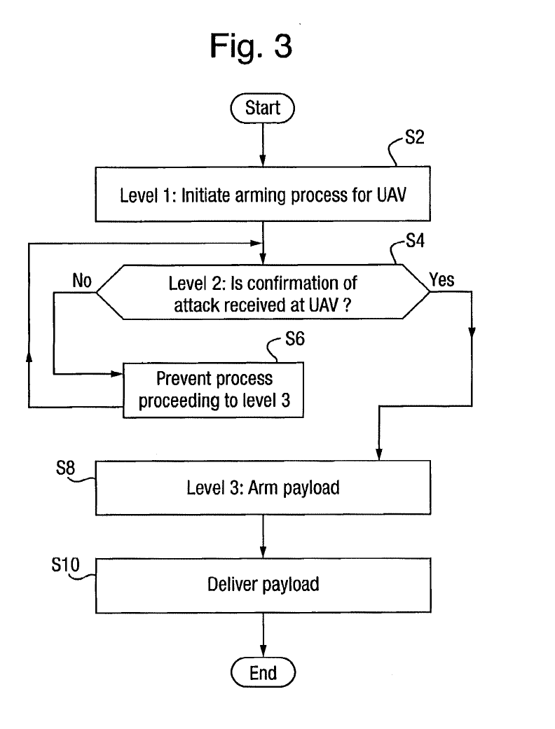

In this example, the payload arming system 4 is coupled to the payload 6 such that two-way communication between the payload arming system 4 and the payload 6 is possible. The payload arming system 4 is used to perform the payload arming and delivery process on the payload 6 which is described in more details later below with reference to FIG. 3.

In this embodiment, the payload arming system 4 and the payload 6 are independent of other UAV systems, for example UAV guidance or control systems (not shown in FIG. 1).

In this example, the payload 6 is a lethal effector, i.e. munitions. For example, the payload 6 may be a free-fall non-precision (i.e. dumb), semi-precision, or precision bomb.

In this example, the payload 6 is capable of being armed, i.e. the payload 6 may be prepared for use. In this example, the payload 6 is armed by releasing a safety device. The releasing of the safety device comprises releasing two levels of safety, namely an electronic safety connection and a mechanical safety connection. The payload 6 is armed by the payload arming system 4 by performing the below described payload arming and delivery process.

In this embodiment, the operation of the payload 6 when in the unarmed state is restricted compared to the operation of the payload 6 when it is in the armed state.

In this embodiment, before being armed, the payload 6 is inert.

In this example, the payload 6 is integrated with the UAV 2, i.e. during operation the payload 6 is not detachable from the UAV 2.

FIG. 2 is a schematic illustration (not to scale) of an example scenario in which the UAV 2 is used to implement the embodiment of the payload arming and delivery process (which is described in more detail later below with reference to FIG. 3).

In this scenario, the UAV 2 payload arming system 4 and the payload 6 is mounted on the UAV 2 at a ground base 8. The UAV 2 is then launched from the ground base 8.

In this scenario, two-way communication between the UAV 2 and the ground base 8 is possible (i.e. signals can be transmitted from the ground base 8 and received at the UAV 2, and vice versa).

In this scenario, the UAV 2 is launched from the ground base 8 with an intention of delivering the payload 6 to a target 10 (i.e. attacking the target 10 with the UAV 2). In this scenario, because the payload 6 is non-detachable from the UAV 2 the payload 6 is delivered to the target 10 by the UAV 2 flying into, or sufficiently near to, the target 10 after the payload 6 has been armed. The payload is then detonated.

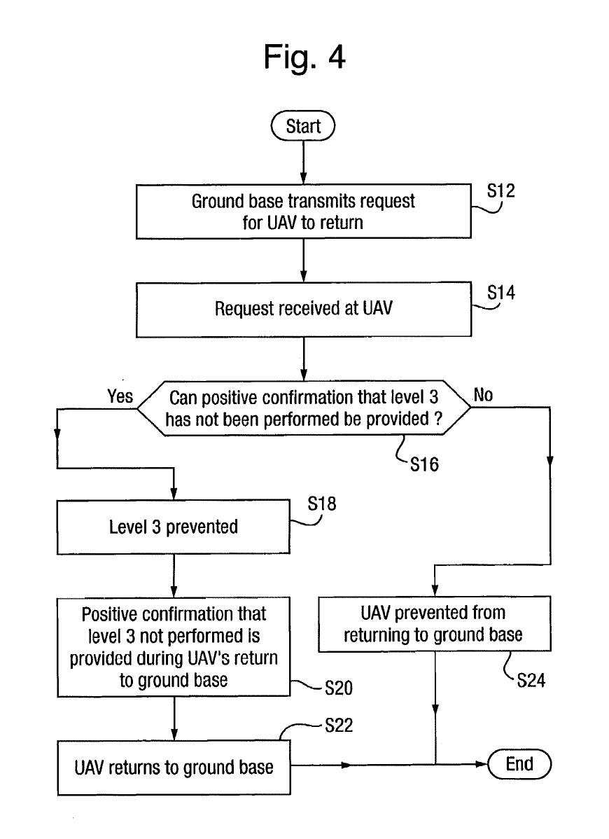

Also, in this scenario, it is possible that, after the UAV 2 has been launched from the ground base 8, the intention that the payload 6 is delivered to the target 10 is changed, e.g. is desired that that the payload 6 is not delivered to the target 10. In this event a process whereby the UAV 2 may be allowed to return to the ground base 8 is performed. This, process is hereinafter referred to as the “UAV return” process and is described in more detail later below with reference to FIG. 4.

FIG. 3 is a process flow-chart showing certain steps of an embodiment of the payload arming and delivery process.

In this embodiment, the UAV 2 has been launched from the ground base 8 and the target 10 for the UAV 2 has been identified.

At step s2, a first level (hereinafter referred to as “level 1”) of the payload arming and delivery process is performed.

In this embodiment, level 1 comprises the payload arming system 4 initiating a payload arming process. In other words, at level 1 the UAV 2 readies itself for arming the payload 6.

In this embodiment, at step s2 a signal originating from the ground base 8 is received at the payload arming system 4 of the UAV 2. This signal may, for example, be received at the payload arming system 4 via a number of different UAV systems. This signal instructs the payload arming system 4 to initiate the arming process.

At step s4, a second level (hereinafter referred to as “level 2”) of the payload arming and delivery process is performed.

In this embodiment, level 2 comprises the payload arming system 4 assessing whether or not confirmation that the target 10 is to be attacked has been received by the payload arming system 4. In this embodiment, this confirmation is provided by a further signal from the ground base 8 to the payload arming system 4 (e.g. via a number of different UAV systems) comprising an identification of the target 10 and an indication that the payload 6 is to be delivered to the target 10.

If, at step s4, confirmation that the target 10 is to be attacked has not been received from the ground base 8, the payload arming and delivery process proceeds to step s6.

However, if, at step s4, confirmation that the target 10 is to be attacked has been received by the UAV 2 from the ground base 8, the payload arming and delivery process proceeds to step s8.

At step s6, the payload arming system 4 prevents the payload arming and delivery process from progressing to step s8 (i.e. the payload 6 is prevented from being armed). In particular, at step s6 a third level (hereinafter referred to as “level 3”) of the payload arming and delivery process is prevented. Level 3 is described in more detail later below with reference to step s8 of the payload arming and delivery process.

After step s6, i.e. after prevention of the arming of the payload 6, the payload arming and delivery process proceeds back to step s4.

Thus, in this embodiment, level 3 of the payload arming and delivery process is prevented from being performed until confirmation that the target 10 is to be attacked has been received by the payload arming system 4 of the UAV 2 from the ground base 8. In other words, it is the payload arming and delivery process does not progress past level 2 (steps s4 and s6) until confirmation of the attack (i.e. identification of the target and an instruction to attack that target) is received by the UAV 2.

Referring back to step s4, if confirmation that the target 10 is to be attacked has been received by the UAV 2 from the ground base 8, the payload arming and delivery process proceeds to step s8.

At step s8, level 3 of the payload arming and delivery process is performed.

In this embodiment, level 3 comprises the payload arming system 4 arming the payload 6. In other words, the payload arming system 4 acts on the payload 6 so as to change the state of the payload, from its inert state to an active, or reactive, state. In this embodiment, the payload 6 is armed by releasing the electronic safety connection and the mechanical safety connection of the safety device on the payload 6. Thus, at step s8 (i.e. level 3) the payload 6 is prepared for use.

At step s10, the armed payload 6 is delivered to the target 10. In this embodiment, the UAV 2 flies into (or sufficiently near to) the target 10. The payload 6 then detonates. Thus, the armed payload 6 is delivered to the target 10.

Thus, a payload arming and delivery process is provided.

What will now be described is a process that is performed in the event that, after the UAV 2 has been launched from the ground base 8, the intention that the payload 6 is delivered to the target 10 is changed, i.e. is decided (e.g. by the ground base 8) that that the payload 6 is not to be delivered to the target 10. This process is the so-called UAV return process.

FIG. 4 is a process flow chart showing certain steps of the UAV return process.

At step s12, the ground base 8 transmits a request that the payload 6 is not delivered to the target 10. In this embodiment, this request comprises a request that the UAV 2 returns the (unarmed) payload 6 to the ground base 8. In other words, the request comprises a request that the payload 6 is transferred in its unarmed state to the ground base 8.

At step s14, the request transmitted by the ground base at step s12 is received by the UAV 2 (and thus the payload arming system 4 on the UAV 2).

At step s16, the payload arming system 4 determines whether or not positive confirmation that the payload 6 has not been armed can be provided. In other words, the payload arming system 4 determines whether or not level 3 (i.e. step s8 of the above described payload arming and delivery process) has been performed and whether or not positive confirmation that level 3 has not been performed can be provided.

If, at step s16, it is determined that positive confirmation that the payload 6 has not been armed can be provided, the UAV return process proceeds to steps s18-s22.

However, if, at step s16, it is determined that positive confirmation that the payload 6 has not been armed can not be provided, the UAV return process proceeds to step s24.

At step s18, the payload arming system 4 prevents the payload 6 being armed. In this embodiment, level 3 (i.e. the arming of the payload 6) is prevented by the payload arming system 4 by, in effect, locking the safety device in place (i.e. preventing the electrical and mechanical connections of the safety device being released). Prevention of the arming of the payload 6 may be provided by, instead of or in addition to locking the safety device, disabling the payload 6 or payload arming mechanism so that the payload 6 can not be armed before the UAV 2 returns to the ground base 8.

At step s20, the UAV 2 begins its return to the ground base 8. In this embodiment, throughout the UAV's return to the ground base 8, the positive confirmation that the payload 6 has not been armed is transmitted from the UAV 2 to the ground base 8. In this embodiment, the payload arming system 4 iteratively checks that the payload 6 is unarmed to generate the positive confirmation throughout the UAV's return to the ground base 8. This positive confirmation is received at the ground base 8 and has an effect of informing the ground base 8 that the payload 6 is not armed (i.e. is in an inert state).

At step s22, the UAV 2 returns to the ground base 8. The payload 6 on the UAV 2 is unarmed (i.e. it is in an inert or inactivated state). Thus, the risk of the payload 6 detrimentally affecting the ground base 8 upon its return tends to be advantageously alleviated or reduced. Moreover, the payload 6 is returned to the ground base 8 unused. Thus, the payload 6 and/or the UAV 2 may be reconfigured, re-conditioned and/or reused, e.g. in a different scenario.

Referring back to step s16, if positive confirmation that the payload 6 has not been armed can not be provided, the UAV return process proceeds to step s24.

At step s24, the UAV 2 is prevented from returning to the ground base 8. In this embodiment, it is assumed that the payload 6 has been armed (i.e. that level 3 has been carried out).

In this embodiment, the UAV 2 is prevented from returning to the ground base 8 and delivering the payload 6 to the target by delivering the payload 6 (i.e. in effect attacking) a location remote from both the ground base 8 and the target 10. Thus, at step s24, the UAV 2 is in effect, deliberately crashed in a relatively isolated region.

Thus, a process by which the UAV 2 and onboard payload 6 may be safely returned to the ground base 8 is provided.

An advantage provided by the above described system and methods is if it is decided that the payload 6 is not to be delivered to the target 10, and hence the payload 6 is not armed, then it tends to be possible to return the UAV 2 to the ground base 8. The UAV 2 and/or payload 6 may then be reused. This tends to preserve resources (e.g. UAVs, munitions, etc.) until they are needed, i.e. until it is desired that the payload 6 is delivered to a target 10. Moreover, costs tend to be reduced.

A further advantage is that a risk to the ground base 8 when returning the payload 6 to the ground base 8 tends to be advantageously reduced. Moreover, positive confirmation that the payload 6 has not been armed is provided from the UAV 2 to the ground base 8 throughout the UAV's return to the ground base 8. This positive confirmation is provided by the payload arming system 4 which iteratively checks that the payload 6 is unarmed. If no such positive confirmation can be provided by the UAV 2, then the UAV 2 is prevented from returning to the ground base 8.

A further advantage is that if it is decided that the payload 6 is not to be delivered to a target (or no target is identified for the payload 6), it tends to be possible to avoid having to deliver the payload 6 to a relatively remote location. This tends to be in contrast to conventional methods in which payloads are effectively abandoned in relatively remote locations instead of being returned. Thus, the risks of detrimentally effecting third parties (e.g. civilians) when abandoning a payload, tend to be reduced or eliminated. Moreover, the risks of unarmed payloads being retrieved by third parties (or an enemy) tend to be reduced or eliminated.

A further advantage of the provided system and method is that the disadvantages of launching the UAV 2 with onboard payload 6 with no specific target identified (e.g. in anticipation of a target being identified) tend to be advantageously reduced. In other words, a UAV 2 can be launched without a specific target being identified, and if no such target is identified, the UAV and unarmed payload can advantageously be returned. This tends to be in contrast to the conventional approach in which if no target is identified, the payload is delivered to a relatively remote location. This advantageously tends to reduce response time for a UAV, i.e. the time taken for a UAV to deliver a payload advantageously tends to be reduced because the UAV may already be airborne.

Apparatus, including the payload arming system 4, for implementing the above arrangement, and performing the method steps described above, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media. Moreover, in other embodiments, one or more components of the payload arming system 4 may be remote from the UAV 2, e.g. the payload arming system 4 may be at the ground station.

It should be noted that certain of the process steps depicted in the flowcharts of FIGS. 3 and 4 and described above may be omitted or such process steps may be performed in differing order to that presented above and shown in the Figures. Furthermore, although all the process steps have, for convenience and ease of understanding, been depicted as discrete temporally-sequential steps, nevertheless some of the process steps may in fact be performed simultaneously or at least overlapping to some extent temporally.

In the above embodiments, an autonomous UAV is used to deliver a payload to a target. However, in other embodiments a different type of entity is used to deliver the payload. For example, a different type of UAV may be used, e.g. a semi-autonomous UAV, or UAV controlled from a remote location (e.g. the ground base) may be used. In other embodiments, a different type of vehicle may be used, e.g. a land based vehicle. Furthermore, in other embodiments the UAV may be of any appropriate size, and have any appropriate dimensions.

In the above embodiments, the payload is a lethal effector. However, in other embodiments the payload may be a different type of payload. For example, in other embodiments the payload is a non-lethal effector, e.g. a communications jamming device, a locator beacon, or equipment for friendly ground-based troops. In other embodiments, the payload is a different type of device that is capable of being armed/activated using an arming system and process.

In the above embodiments, the payload is integrated with the UAV, i.e. during operation the payload is not detachable from the UAV. Thus, in the above embodiments, delivery of the payload comprises flying the UAV into, or sufficiently close to, a target. However, in other embodiments the payload may be detachable from the UAV. In such embodiments, delivery of the payload to a target may, for example, comprises detaching the payload (i.e. dropping the payload) from the UAV, e.g. as the UAV passes over or near the target.

In the above embodiments, the UAV comprises a single payload for delivery to a single target. However, in other embodiments the UAV may comprise a different number of payloads, i.e. more than one payload, for example for delivery to one or more targets.

In the above embodiment, UAV is prepared at, launched from, and potentially returned to a ground base. However, in other embodiments the UAV may be prepared at a different location. Also, in other embodiments, the UAV may be launched from a different location, for example from an aircraft. Also, in other embodiments, the UAV may be returned to a different location, for example, a further ground base, in the event that the payload is not armed and no target is identified.

In the above embodiments, the above described system and processes are implemented in the scenario described above with reference to FIG. 2. However, in other embodiments the above described system and methods are implemented in a different scenario. For example, in other embodiments there may be a different number of UAVs.

In the above embodiments, the UAV is launched from the ground base with an intention of delivering the payload to a target. However, in other embodiments, the UAV may be launched under different conditions. For example, the UAV could be launched with no specific target identified, but in anticipation that a target for the UAV will be identified at a future point in time while the UAV is airborne.

In the above embodiments, the ground base transmits a request comprising an instruction that the UAV returns the unarmed payload to the ground base. However, in this embodiment, such an instruction is not provided by the ground base. For example, in other embodiments this instruction can received at the UAV from a different entity, or the instruction can be part of a series of operating instructions loaded onto the UAV prior to the UAV being launched (e.g. an instruction that the UAV returns the unarmed payload to the ground base if, after a predetermined amount of time in the air, no target has been identified for the UAV).

In the above embodiments, at step s18 the payload arming system prevents the payload being armed by, in effect, locking the safety device in place (i.e. preventing the electrical and mechanical connections of the safety device being released). However, in other embodiments prevention of the arming of the payload is provided by a different action instead of or in addition to locking the safety device. For example, in other embodiments the arming of the payload may be disabled, e.g. in such a way that this disabling cannot be overcome or overridden by means other than by (manually and mechanically) reconditioning the UAV and payload upon the UAV's return to the ground base. In other words, in other embodiments, the mechanism by which the payload is armed may be disabled.

In the above embodiments, at step s20, throughout the UAV's return to the ground base, the positive confirmation that the payload has not been armed is transmitted from the UAV 2 to the ground base 8. In the above embodiments, the payload arming system iteratively checks (i.e. at a number of different time-steps) that the payload is unarmed and generates a positive confirmation at each of those time-steps. Signals corresponding to those confirmations are provided to the ground base as they are generated. However, in other embodiments, positive confirmation that the payload is not in an armed state is provided to the ground base in a different way. For example, in other embodiments, a single confirmation signal is sent from the UAV to the ground base confirming that the arming mechanism of the payload has been disabled and that the payload is disarmed.

1. A method performed by an apparatus, the apparatus being wholly or partially mounted on an unmanned vehicle and arranged to act upon a payload, the payload being mounted on the unmanned vehicle and, under an action of the apparatus, being changeable from a first state to being in a second state, the method comprising:
receiving an instruction that the unmanned vehicle, with the payload mounted thereon, is to travel to a location;
determining that the payload is in the first state; and
responsive to the step of determining that the payload is in the first state:
opposing the payload being changed to being in the second state; and
providing, for an entity remote from the unmanned vehicle, an indication that the payload is in the first state.

2. A method according to claim 1, wherein operation of the payload in the first state is restricted compared to operation of the payload in the second state.

3. A method according to claim 1, wherein the step of opposing the payload being changed to being in the second state comprises:
disabling a mechanism by which the payload is changed to being in the second state.

4. A method according to claim 1, wherein the step of opposing the payload being changed to being in the second state comprises:
opposing release of a safety device.

5. A method according to claim 4, wherein the safety device comprises an electrical connection and a mechanical connection.

6. A method according to claim 1, wherein the entity is at the location.

7. A method according to claim 1, wherein the payload is a lethal effector.

8. A method according to claim 1, wherein the step of providing, for an entity remote from the unmanned vehicle, an indication that the payload is in the first state is performed at a plurality of time-steps in a time period.

9. A method according to claim 1, wherein the apparatus is integral with an unmanned vehicle, the method comprising:
sending the unmanned vehicle, with the payload mounted on the unmanned vehicle, to the location.

10. A method according to claim 9, wherein the time period extends at least from a first point in time to a second point in time, the first point in time being a point in time at which the instruction is received, and the second point in time is a point in time at which the unmanned vehicle arrives at the location.

11. Apparatus for at least partial mounting on an unmanned vehicle so as to act upon a payload which is mounted on the unmanned vehicle and which, under an action of the apparatus, is able to be changed from being in a first state to being in a second state, the apparatus being configured to:
receive an instruction that an unmanned vehicle, with a payload mounted thereon, is to travel to a location;
determine that the payload is in a first state; and
in response to determining that the payload is in the first state, the apparatus being configured to:
oppose the payload being changed to being in the second state; and
provide, for an entity remote from the unmanned vehicle, an indication that the payload is in the first state.

12. Apparatus according to claim 11, comprising in combination:
the payload, wherein operation of the payload in the first state is restricted compared to operation of the payload in the second state.

13. Apparatus according to claim 12, wherein opposing the payload being changed to being in the second state comprises:
disabling a mechanism by which the payload is changed to being in the second state.

14. A program or plurality of programs arranged such that when executed by a computer system or one or more processors it/they cause the computer system or the one or more processors to operate in accordance with the method of claim 1.

15. A machine readable non-transitory storage medium for storing a program, or at least one of the plurality of program, according to claim 14.
